(19) United States
(12) Patent Application Publication
(10) Pub. No.: US 2001/0025889 A1
(43) Pub. Date: Oct. 4, 2001

(54) Arrangement for supplying heat to a motor vehicle when the vehicle's engine is not running

(75) Inventor: Per Salberg, Nykvarn (SE)

Correspondence Address: OSTROLENK FABER GERB & SOFFEN, 1180 AVENUE OF THE AMERICAS, NEW YORK, NY, 100368403

(73) Assignee: SCANIA CV AB (pub1)

(21) Appl. No.: 09/825,557

(22) Filed: Apr. 2, 2001

(30) Foreign Application Priority Data
Apr. 3, 2000 (SE) 0001179-1

(51) Int. Cl. B60H 1/22

(52) U.S. Cl. 237/12.1; 237/12.3 R

(57) ABSTRACT

An arrangement for supplying heat to a motor vehicle when the vehicle engine is not running. At least one component is operated by electrical energy from a battery in the motor vehicle during the heat supplying to the vehicle and particularly for heating an interior space in the vehicle. An alarm which is activated when the voltage of the battery reaches a lowest acceptable level informs a drive to be able to prevent further lowering of the voltage level of the battery. The heat supply component may be a burner or may be the circulating engine coolant system and may include a fan.

### BACKGROUND OF THE INVENTION, AND STATE OF THE ART

The present invention relates to an arrangement for supplying heat to a motor vehicle when the vehicle's engine is not running and to an alarm system which operates when the heating system operation discharges that vehicle's electric battery to a low level.

In heavy-duty freight vehicles, so-called extra heaters are often used for heating the driver's cab according to need when the vehicle's engine is not running. Such extra heaters are designed to supply heat to the cab when, for example, the driver is resting or overnighting in the cab. Extra heaters usually include at least some components which require electrical energy supplied from the vehicle's battery to operate them.

Using such an extra heater for a prolonged period entails the risk that the electrically driven components may discharge the battery to such an extent as to make it difficult for the driver to start the vehicle's engine with the remaining battery voltage. This problem is solved in known extra heaters by incorporating in them an arrangement which enables the electrically driven components to be disconnected automatically when the battery voltage reaches a low level likely to make the vehicle's engine difficult to start. Such automatic disconnection entails, however, another problem in the form of risk that a driver sleeping in the cab may be awakened by cooling of the cab.

### SUMMARY OF THE INVENTION

The object of the present invention is to provide an arrangement of the kind mentioned in the introduction which informs a driver in a clear and unmistakable manner when the battery voltage reaches a lowest acceptable level.

This object is achieved with the arrangement of the kind mentioned in the introduction which operates when the voltage of the vehicle battery reaches a lowest acceptable level. The vehicle includes a heat supply system, such as a burner, or the engine cooling system or a heater which is designed to be driven by the electrical energy from the at least one battery in the vehicle. When the electrical energy level of the battery reaches a low level and particularly the lowest acceptable level, an alarm connected with the battery and including a sensor for sensing the battery level alerts an operator who can then decide whether to shut down the heat supply system to preserve battery energy. An alarm is used to alert the driver in a very obvious manner to the fact that the battery voltage has dropped to a lowest acceptable level and that further use of the arrangement may lead to the vehicle's engine being difficult to start. A driver awakened by the alarm may choose, for example, to switch off the heating arrangement or to start the engine and run it for a while in order to charge the battery. The driver thus has obvious prior notice of a critical state of the battery and therefore runs no risk of having his vehicle stationary with its battery discharged through lack of information.

According to a preferred embodiment of the present invention, said alarm is designed to deliver an acoustic signal. A suitably loud acoustic signal can even wake a deeply sleeping driver to alert him to the fact that the battery voltage has dropped to a lowest acceptable level. Other types of alarm are also not inconceivable. Such alternative alarms may for example deliver light signals or vibrations.

According to another advantageous embodiment of the present invention, the supply of heat to the vehicle by the arrangement is designed to be discontinued when the battery voltage reaches said lowest acceptable level. Continued energy supply from the battery to said components is thereby prevented and the battery voltage is prevented from dropping further. The components cease to operate and the heat supply to the vehicle ceases. The arrangement may incorporate, to monitor the battery voltage level, a voltmeter which measures the battery voltage substantially continuously and a circuit-breaker which is designed to disconnect the supply of electrical energy to said components automatically when the battery voltage reaches said lowest acceptable level.

According to another preferred embodiment of the present invention, the arrangement is designed to make it possible to heat an interior space of the motor vehicle. With advantage, the arrangement is used to heat an interior space in the form of a driver's cab of the motor vehicle in which the driver has the possibility of resting or overnighting. Alternatively or in combination with heating the interior space, heat may be supplied to the vehicle's engine so that the latter maintains a temperature acceptable for starting purposes when the outside temperature is low. To make it possible to supply heat to the interior space in the vehicle, the arrangement may include means designed to heat the air which is supplied to the interior space. The air supplied has with advantage such a temperature and is supplied in such quantity as to maintain a substantially constant temperature in the interior space. Said means may include a burner designed to be operated by means of a fuel supply. With advantage, the burner is operated by the same kind of fuel as the vehicle, which is usually diesel fuel for heavy freight vehicles. Operating such a burner causes no load on the vehicle's battery. Moreover, operating the burner does not require any further fuel than diesel fuel which can be supplied from the vehicle's fuel tanks. According to one embodiment, the burner can directly heat the air intended to be supplied to the interior space. According to an alternative embodiment, said means may include a cooling system of the vehicle whereby the coolant of the cooling system is designed to be heated in order thereafter to impart its heat to the air intended for supply to the interior space. Using, for example, a burner to heat the coolant in the system makes it possible for the hot coolant to be used, in the same way as when the vehicle's engine is running, to heat the air supplied to the interior space. Heating the coolant of the cooling system also provides the vehicle's engine with heating so that cold starts are avoided. If said means include an existing cooling system in the vehicle, the construction of the arrangement in the vehicle entails the supply of a smaller number of components.

According to another preferred embodiment of the present invention, the cooling system incorporates an electrically driven first component in the form of a pump designed to circulate the coolant in the cooling system. The arrangements may include equipment for using electrical energy from the battery to drive an existing water pump to provide coolant circulation when the vehicle's engine is not running. To lead the heated air into the vehicle's interior, the arrangement includes an electrically driven second component in the form of a fan designed to supply the interior with air heated by said means. With advantage, said fan is an existing interior fan in the vehicle which is also driven by electrical energy supply when the vehicle is running.

According to another preferred embodiment of the present invention, the arrangement includes a control unit by which the heat supply to the vehicle can be controlled and desired heating parameters can be set. Such parameters may for example be the desired temperature in the interior and the period of time for which heat supply is desired.

### BRIEF DESCRIPTION OF THE DRAWING

A preferred embodiment of the invention is described below by way of example with reference to the attached drawing, in which:

FIG. 1. depicts schematically an embodiment of an arrangement according to the present invention.

### DETAILED DESCRIPTION OF A PREFERRED EMBODIMENT OF THE INVENTION

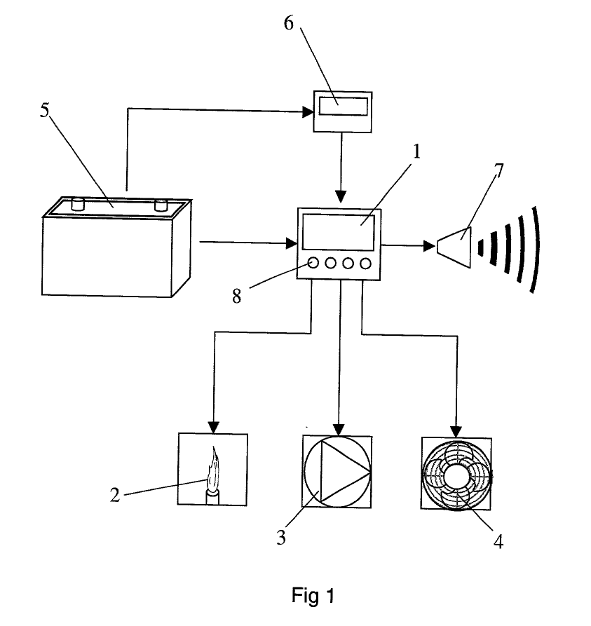

FIG. 1 depicts schematically an arrangement for supplying heat to a motor vehicle when the vehicle's engine is not running. The arrangement includes a control unit 1 by which a driver can control the supply of heat to an interior space of the vehicle when the vehicle's engine is not running. The driver can use the control unit 1 to set desired heating parameters such as, for example, the desired temperature in the interior and the period of time for which heat supply is desired. The control unit 1 is therefore designed to activate and control the fuel supply to a burner 2 so that it provides desired heating of the air which is intended for supply to the vehicle's interior. The burner 2 is operated by supply of the vehicle's fuel, which is, with advantage, diesel fuel. There is therefore no need to store a further type of fuel in the vehicle in order to guarantee the functioning of the burner 2. According to the embodiment in FIG. 1, the burner 2 is designed to heat the air supply to the interior indirectly by heating coolant in the vehicle's existing cooling system. The control unit 1 is designed to make it possible to activate a water pump 3 existing in the cooling system in order to circulate coolant in the cooling system. The control unit 1 is also designed to make it possible to activate an existing interior fan 4 which is designed to make it possible to circulate air past heat-imparting surfaces of the cooling system. Thereafter the interior fan 4 leads the heated air into the interior. The water pump 3 and the interior fan 4 may be driven by electrical energy supply from a battery 5. A voltmeter 6 is designed to measure the voltage level of the battery 5 substantially continuously. The voltmeter 6 is usually existing equipment in a vehicle and can be incorporated in the arrangement. The control unit 1 is designed to receive information on the voltage level of the battery 5 substantially continuously from the voltmeter 6. The control unit 1 is also connected to an alarm 7. The alarm 7 is designed to be activated by the control unit 1 and deliver an acoustic signal when the voltage level of the battery 5 drops to a lowest acceptable level. This level corresponds with advantage to the voltage required in the battery 5 for it to be possible to start the vehicle's engine without difficulty.

When he wishes to rest or overnight in his parked vehicle, the driver uses a button or knob device 8 or the like on the control unit 1 to set, for example, the desired temperature in the vehicle's interior. The driver may also use the control unit 1 with advantage to set the period of time for which the maintenance of said temperature in the interior is desired. The control unit 1 may also include a wakening function. The driver may thus set the time at which he wishes to be awakened. This wakening is also preferably achieved by means of the alarm 7. The alarm 7 may possibly deliver different types of signals when the driver is awakened at a predetermined desired time and when the alarm 7 starts in order to indicate that the voltage of the battery 5 has dropped to a lowest acceptable level. When the driver uses the control unit 1 to set the desired heating parameters and the arrangement starts up, the burner 2 is activated. The control unit 1 controls the fuel supply to the burner 2 so as to cause a desired amount of heating of coolant in the vehicle's cooling system. The control unit 1 also makes it possible to supply electrical energy from the battery 5 to the water pump 3 of the cooling system. The arrangement incorporates suitable equipment to enable the existing water pump 3 usually driven by the engine to be driven alternatively by supply of electrical energy. The control unit 1 also makes it possible to supply electrical energy from the battery 5 to at least one electrically driven interior fan 4. The interior fan 4 is so placed as to lead air past heat-transmitting surfaces of the cooling system. Air is thus heated and supplied to the interior. The control unit 1 controls the fuel supply to the burner 2 and the electrical energy supply to the water pump 3 and the interior fan 4 so that a temperature desired by the driver is maintained in the interior. To make effective interior temperature control possible, the control unit 1 may receive substantially continuous information on the temperature prevailing in the interior, e.g. from a temperature sensor arranged in the interior. The control unit 1 is also designed to receive substantially continuous information on the voltage level of the battery 5 from the voltmeter 6.

After a long journey, when the driver usually wishes to rest, the voltage level in the battery 5 is usually so high that normal use of the arrangement will not generally lead to the voltage of the battery 5 dropping to a lowest acceptable level. Only if the battery 5 is worn or damaged and/or the heating requirement is very large and prolonged is the problem of the battery 5 reaching an unacceptably low voltage level likely to arise. If the control unit 1 receives information from the voltmeter 6 that the voltage of the battery 5 has dropped to said lowest acceptable level, the control unit 1 activates the alarm 7. The alarm 7 delivers a loud enough acoustic signal to wake a sleeping driver. This signal from the alarm 7 may, as mentioned above, differ from a preset ordinary wakening signal. The driver is informed unmistakably by said signal that the voltage of the battery 5 has dropped to a lowest acceptable level. With advantage, the control unit 1 simultaneously disconnects the electrical energy supply from the battery 5 to the water pump 3 and the interior fan 4. The water pump 3 and the interior fan 4 stop and the heat supply to the vehicle's interior ceases. In this situation the driver may decide whether he wishes to go back to sleep and wake up in a cold interior or to start the vehicle's engine and run it in order to charge the battery 5.

The invention is in no way limited to the embodiment depicted in the drawing but may be varied freely within the scopes of the patent claims. For example, heat may be supplied directly to the air which is led into the vehicle's interior, e.g. by means of a burner. The arrangement need not necessarily include a burner to supply heat, which may instead be supplied to the air by means of substantially any design. Alternatively, parts other than the vehicle's interior may be supplied with heat, e.g. the vehicle's engine, thereby avoiding cold starts.

1. In a motor vehicle having an engine which selectively operates or does not operate;
an electric battery in the vehicle;
a heat supply system for supplying heat in the vehicle when the engine selectively does not operate, the heat supply system including:
a component operable by electrical energy to cooperate in supplying heat to the vehicle, the component being connected to the battery to receive electrical energy therefrom;
a sensor to sense the battery voltage;
an alarm connected with the battery and the sensor such that the alarm is activated when the sensor senses that the battery voltage has decreased to a low acceptable level.

2. In the motor vehicle of claim 1, the battery being electrically connected to the vehicle engine for supplying energy for starting the engine operating, and for being charged by the engine when the engine is operating.

3. In the motor vehicle of claim 1, the alarm being adapted to deliver an acoustic signal when the alarm is activated.

4. In the motor vehicle of claim 1, the heat supply system being connected with the battery so that the heat supply system discontinues supplying heat when the voltage of the battery decreases to the low acceptable level.

5. In the motor vehicle of claim 1, the vehicle having an interior space and the heat supply system being of a type and being so positioned as to heat the interior space of the vehicle.

6. In the motor vehicle of claim 5, the heat supply system including an air heater for heating air and for supplying air to the interior space of the vehicle.

7. In the motor vehicle of claim 6, the air heater comprising a burner operable by a supply of fuel.

8. In the motor vehicle of claim 6, the air heater including a cooling system for cooling the engine including engine coolant in the engine cooling system, the heat supply system being adapted to heat the coolant in the cooling system and the cooling system being disposed in the vehicle so that the heated coolant may heat air which is to be supplied to the interior space of the vehicle.

9. In the motor vehicle of claim 8, the cooling system including an electrically driven pump that is connected with the battery and is disposed in the cooling system for circulating the coolant through the cooling system.

10. In the motor vehicle of claim 9, an electrically driven fan positioned for supplying air heated by the heat supply system to the interior space of the vehicle.

11. In the motor vehicle of claim 6, an electrically driven fan positioned for supplying air heated by the heat supply system to the interior space of the vehicle.

12. In the motor vehicle of claim 5, a control unit so connected with the heat supply system as to control the supply of heat to the vehicle and to set desired heating parameters in the vehicle.

13. The arrangement of claim 1, a control unit so connected with the heat supply system as to control the supply of heat to the vehicle and to set desired heating parameters in the vehicle.
